(19) United States
(12) Patent Application Publication
(10) Pub. No.: US 2016/0222987 A1
(43) Pub. Date: Aug. 4, 2016

(54) HYDRAULIC ACCUMULATOR AND METHOD FOR RECOVERING ENERGY IN A HYDRAULIC SYSTEM

(71) Applicants: Ricardo Lera GOMES, Sao Jose dos Campos (BR); TM INVESTOR LTD, Tallinn (EE)

(72) Inventor: Ricardo Lera GOMES, Sao Jose dos Campos (BR)

(73) Assignee: TM INVESTOR LTD, Tallinn (EE)

(21) Appl. No.: 15/021,946

(22) PCT Filed: Sep. 16, 2013
(86) PCT No.: PCT/EP2013/002779

§ 371 Date: Mar. 15, 2016

(51) Int. Cl. F15B 1/02; F15B 13/02

(52) U.S. Cl. CPC F15B 1/024; F15B 1/025; F15B 13/029; F15B 2201/00

(57) ABSTRACT

The hydraulic energy converter can be connected to a hydraulic system. The converter comprises a manifold device for controlling hydraulic fluid flow, a controller for controlling the manifold device, and at least one accumulator connected to the manifold device, for storing hydraulic energy supplied by the hydraulic system via the manifold device.

This invention relates to a hydraulic energy converter and a method for working a hydraulic system.

In hydraulic systems, hydraulic drives such as rotational drives or linear drives are employed. During the strokes of a hydraulic machine, hydraulic energy is employed for moving a load. The motion of a load, however, does under certain circumstances imply a pressure on the hydraulic fluid used. For instance, if a rotational hydraulic motor drives a winch for lifting and lowering an elevator, the hydraulic system will supply energy for lifting the elevator. On the other hand, the downward motion of the elevator entails additional stress to the hydraulic system due to the gravitational force acting upon the hydraulic motor. This eventually leads to a rise of pressure in the hydraulic system which in turn leads to an energizing of the hydraulic fluid, e.g. oil. This excess energy is dissipated into heat which requires considerable effort with respect to cooling the system for preventing overheating and eventually failure.

In any respect, prior art systems waste energy at the risk of a malfunction.

It is therefore an object of the present invention to provide a solution to this problem that on the one hand reduces the energy waste or dissipation within a hydraulic system, and on the other hand reduces the amount of cooling necessary to run the hydraulic system safely.

This object is solved by a hydraulic energy converter according to claim 1 and a method for working a hydraulic system according to claim 6. Favorable embodiments are set forth in the dependent claims.

According to the invention, the hydraulic energy converter can be connected to virtually any hydraulic system, especially the ones employing a counterbalance valve. The inventive converter comprises a manifold device for controlling hydraulic fluid flow, a controller for controlling the manifold device, and at least one accumulator connected to the manifold device, for storing hydraulic energy supplied by the hydraulic system via the manifold device.

Generally, the converter picks up energy from the hydraulic system in that hydraulic fluid energy is stored in at least one accumulator. This energy is created by the hydraulic motor of the hydraulic system as mechanical energy acting upon the fluid. The motion of the load connected to the hydraulic motor produces energy to the fluid which is eventually fed into the hydraulic system, the hydraulic motor works as a generator in this case. As energy is added to the hydraulic fluid, a force is acting on it which leads to an increase of pressure within the fluid resulting in higher fluid energy. This again results in a velocity increase when passing through the counterbalance valve. Higher velocity will result in a pressure drop. The fluid gains kinetic energy. This kinetic energy is picked up by the converter to actually load an accumulator. The accumulated energy may then be re-fed to the hydraulic system whenever a demand of energy arises. This usually happens whenever the hydraulic system has to invest work rather than being in a generator mode.

The manifold device is controlled by the controller in a way that the energy to or from the accumulator is directed to or from the hydraulic system depending on the respective demand of the hydraulic motor.

Depending on the mode of operation, the hydraulic converter can be operated in two different modes: the intermittent mode and the continuous mode. For the latter, the inventive converter may be equipped with two accumulators that are connected to the manifold device. This is particularly applicable to systems in which a linear drive is powered that comprises a piston with a plunger which is moved by the hydraulic fluid. With each motion of the plunger, hydraulic fluid is compressed. This compression energy is supplied to the converter and stored by one of the accumulators, whereas the other supports the motion in the same direction by feeding energy from the accumulator for driving the plunger.

In a specific embodiment, the converter comprises at least one inlet line connected to the manifold device, for receiving hydraulic fluid from a hydraulic system. This is provided in order to store hydraulic energy in said at least one accumulator. In addition, this supply line is further adopted for supplying hydraulic fluid pressurized by the energy stored in said at least one hydraulic accumulator, to said hydraulic system.

Further, a second line is preferably connected to the manifold device in order to release the energy collected in the manifold back to an oil reservoir of the hydraulic system or to conduct the energy directly from the pump of the hydraulic system into the accumulator. The latter is to compensate for any pressure drop inside the manifold due to leakage effects, e.g. leakage of the valves employed.

The manifold comprises at least one switch for allowing a fluid flow from and/or to said at least one accumulator. The controller is then linked to the switch or switches, which are preferably valves. In this way, the amount of energy accumulated in the accumulator or the amount of energy released therefrom can be precisely controlled.

According to a further aspect of the invention, there is provided a method for working an hydraulic system, which system comprises an hydraulic drive driven by hydraulic fluid flow and hydraulic lines to provide hydraulic fluid flow to and from said hydraulic drive. The hydraulic system is preferably of the type using a counterbalance valve which is passed by the flow of the fluid on its way to the hydraulic motor or drive of the system. In the inventive method, the system comprises—preferably in line with said counterbalance valve—a hydraulic converter, particularly as discussed above. According to the method of the invention, the converter stores energy produced by fluid flowing back from said hydraulic drive in at least an accumulator, if the pressure of the fluid flowing back exceeds a threshold value, and the converter supplies energy, stored in the accumulator, to the hydraulic drive, in case said drive requires energy.

In one embodiment, the converter uses two accumulators, one receiving energy from the hydraulic drive, and simultaneously, the other supplying energy to the hydraulic drive.

The present invention recovers the fluid energy used by the system and stores it for future use. When applied to hydraulic systems, it can bring significant reductions in energy costs. In some applications the reduction exceeds the level of 50% savings of the power demanded for operating the same equipment without the adoption of this invention.

In the following, the invention is discussed with reference to the attached drawings. For the skilled person skilled in the art is clear, that even if figures and the corresponding text show and reveal separate embodiments, features of one embodiment may be combined with another embodiment of the invention. The inventive concept is not limited to the exact diagrams shown in the figures, but may be realized by using other components not shown. In the drawings, same reference numerals depict same or similar components in other drawings.

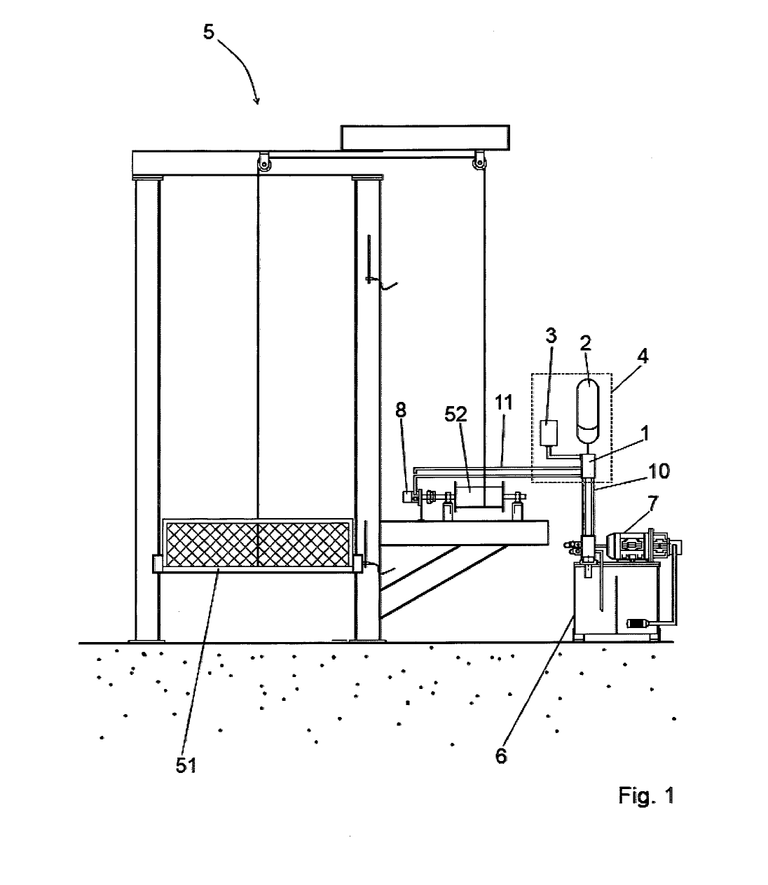

FIG. 1 shows an application of the inventive hydraulic energy converter within a hydraulic system driving an elevator.

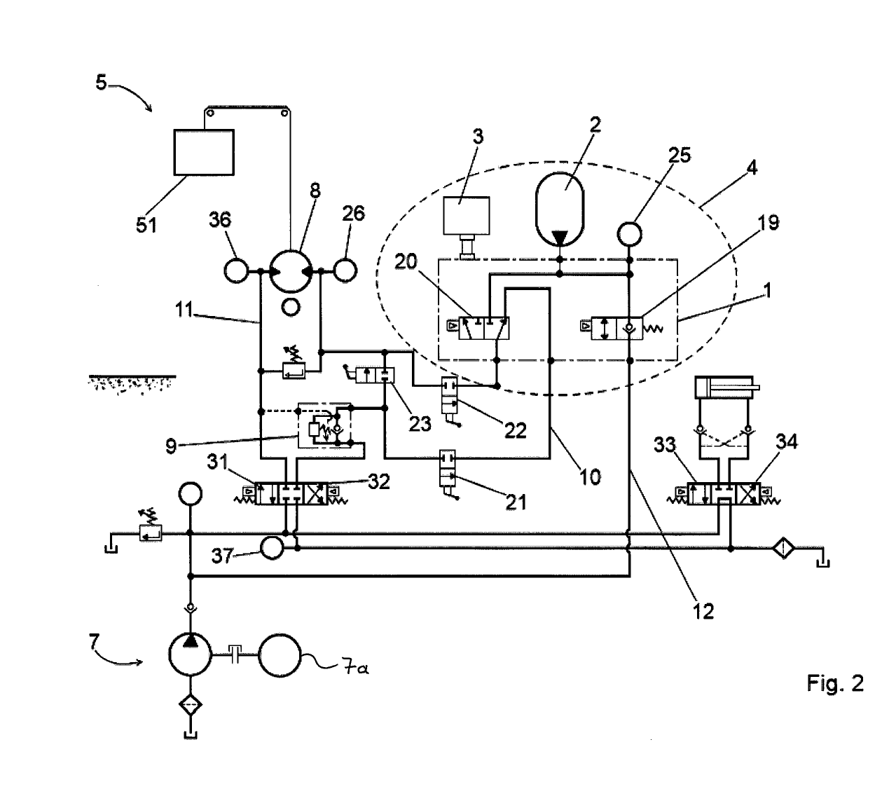

FIG. 2 shows a hydraulic diagram of the hydraulic system of FIG. 1.

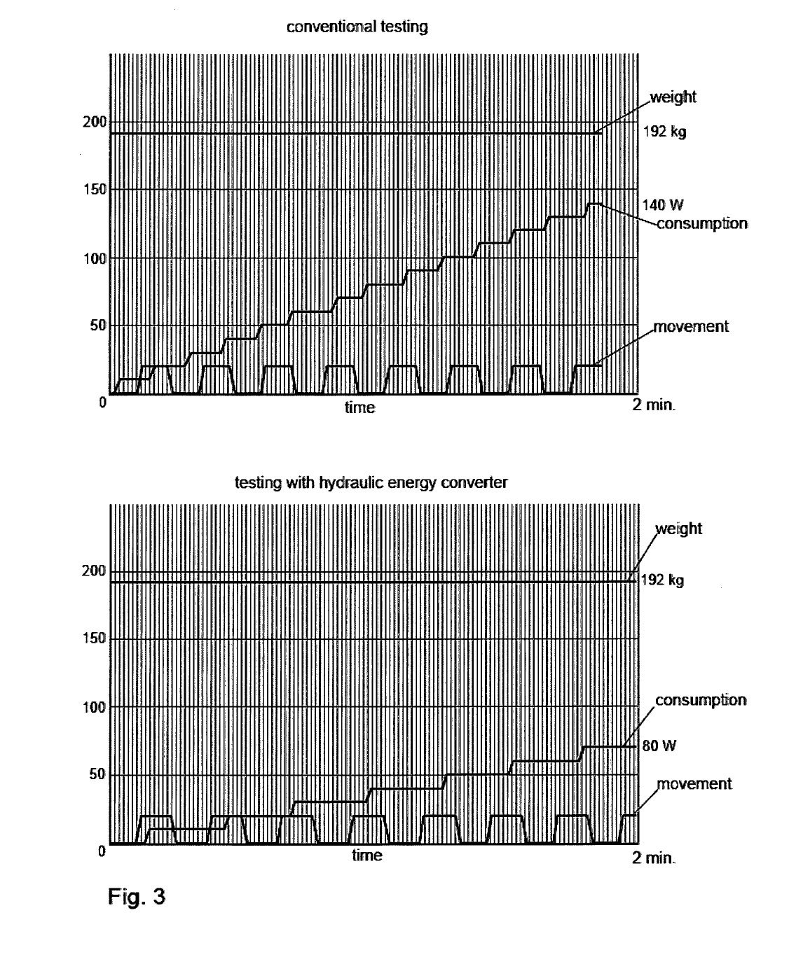

FIG. 3 shows two graphs comparing tests of a prototype hydraulic system involving an elevator driven by a prototype hydraulic system, showing a testing without the use of the hydraulic energy converter (top) and with use of the hydraulic converter—placed after the counterbalance valve—according to the present invention (bottom).

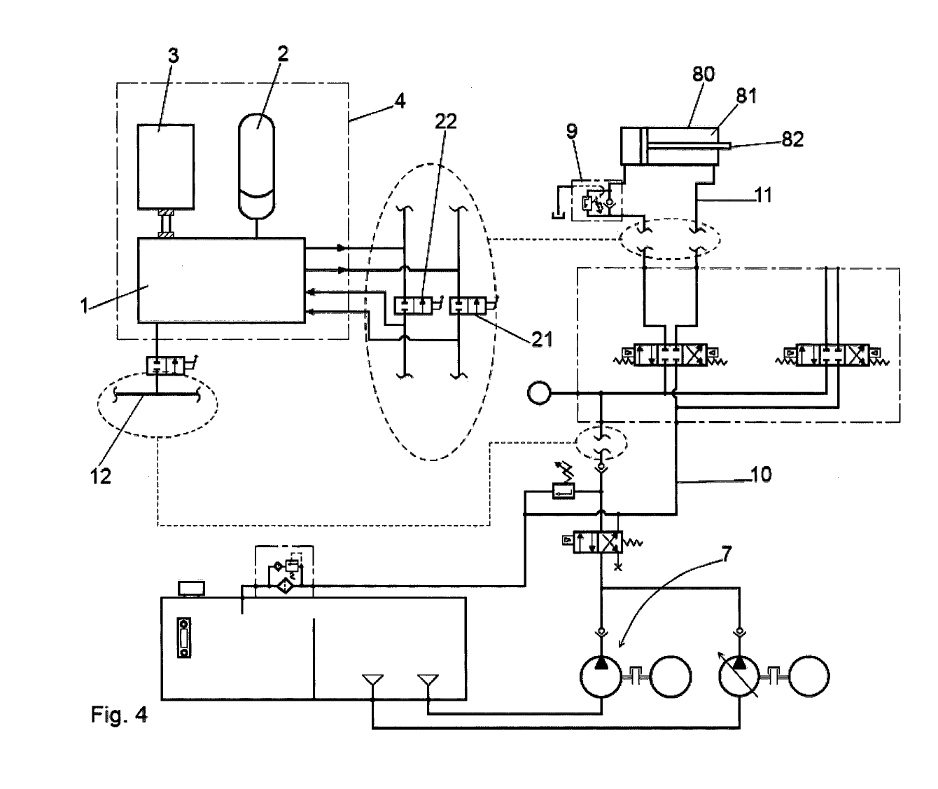

FIG. 4 shows a hydraulic diagram of a hydraulic linear actuator for lifting loads using the inventive hydraulic energy converter after a counterbalance valve in an embodiment configured for an intermittent operation.

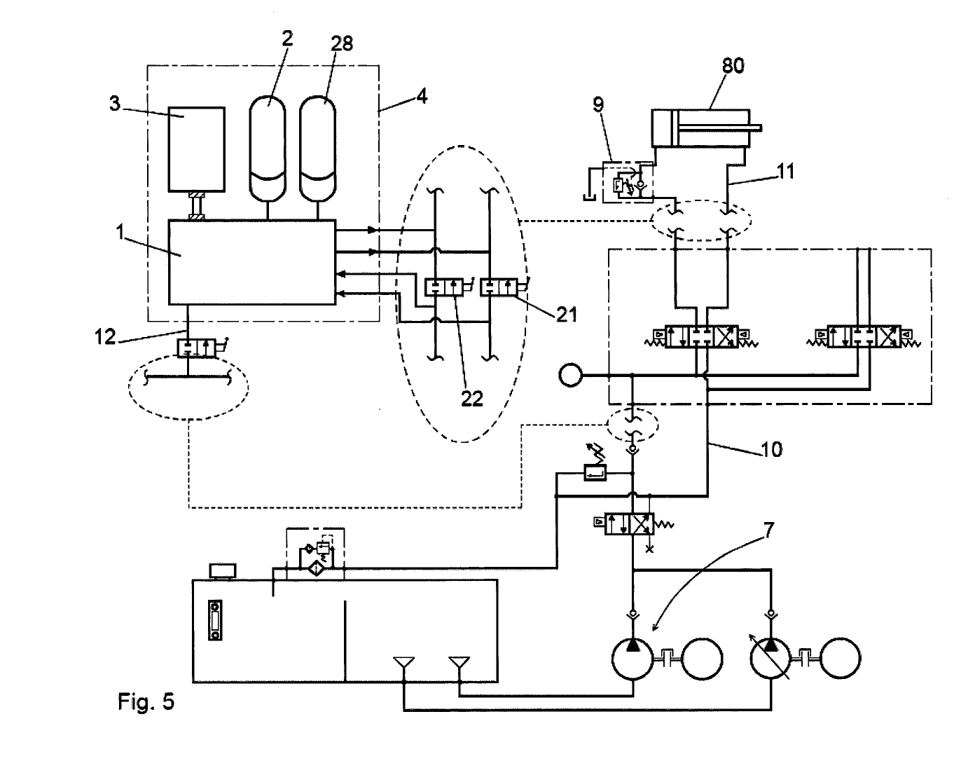

FIG. 5 shows a hydraulic diagram of a hydraulic linear actuator for lifting loads using the inventive hydraulic energy converter after a counterbalance valve in another embodiment configured for a continuous operation.

Turning to FIG. 1, the hydraulic energy converter 4—hereinafter simply referred to as “converter” is to be connected to lines 10, 11 of a hydraulic system. In the case shown, the hydraulic system has a reservoir 6 for hydraulic fluid (hereinafter simply called “fluid”), such as oil or the like. A pump 7 supplies the fluid to the hydraulic drive 8—in the present case a rotational hydraulic motor—via lines 10 and 11. The hydraulic motor is connected to a load, particularly to the car 51 of an elevator 5 by means of a rope that is wound on a drum 52 connected to the shaft of the hydraulic motor 8.

The converter 4 comprises basically of a manifold device or block 1 made to receive valves and sensors, which make up and represent the hydraulic operation logic of a particular application, in addition to one or more accumulators 2 and programmable logic controller 3.

Likewise diagrams 4 and 5, the hydraulic diagram of FIG. 2 exemplifies the application of the converter to an hydraulic system used for driving a load. In case of FIG. 2, the load is an elevator 5 driven by a rotational hydraulic motor 8. In FIGS. 4 and 5, two examples for driving a linear hydraulic motor are given. All examples commonly include idea to use valves to divert the flow of fluid (oil), either accumulating or supplying energy. Hydraulic accumulators 2 accumulate energy. The programmable logic controller 3 has the function of operating the valve(s) during the hydraulic system cycle and provides the efficiency over time of digital controlling.

Moreover, when installed in a hydraulic system, the converter 4 absorbs energy from the high-speed flows, which is dissipated as heat into the hydraulic fluid. Energy returns it to the system energy needed for work execution of one or more hydraulic actuators 8 depending on the application. The stored energy levels are related to the hydraulic actuators 8 size and strokes, thus reserving the commitment with the dimensions of each hydraulic application.

The converter operates as follows: The invention provides two different modes of operation, the intermittent model and the continuous model. For the intermittent model requires one accumulator, the continuous model requires two accumulators.

FIG. 2 shows an example for an intermittent model. This type is designed to recover the fluid energy on the downward movement of the elevator car 51 and to supply fluid energy on the upward movement of the car 51.

The manifold 1 represents the hydraulic logic diagram to work in series the hydraulic energy converter 4 and the counterbalance valve 9. The manifold 1 is in the example shown, provides with switches, in this case one 3/2 single solenoid valve 20, one 2/2 single solenoid valve 19, and a pressure transmitter 25 to measure the pressure inside the accumulator 2. The valve 3/2 single solenoid 20, when de-energized, is connecting the fluid energy to the counterbalance valve 9, and when it the valve 20 is energized, is connecting the fluid energy to the accumulator 2. The 2/2 single solenoid 19 is connecting the accumulator 2 to a pressure line 12, this valve 19 is responsible for directing the fluid energy to the oil reservoir 6 and also to load fluid energy from the pump 7 to the accumulator 2.

The control unit 3 processes the commands of movements, upward and downward using the converter 4.

When the movement of the car 51 is downward, the control unit 3 energizes the valve 20, reads the pressure at 26, and when it receives maximum pressure possible, the control unit 3 de-energizes the valve 20, switching the flow to the counterbalance system 9.

When the movement of the car 51 is upward, the control unit 3 checks the pressure at 25. If this is in within a given high and low threshold value, the controller is ready to energize the valve 20. If not, the controller 3 turns on the pump 7, turns on the valve 19, and when it reaches a sufficient pressure at 25, turns off both the valve 19 and the pump 7; this is simply to fill up the system with the necessary missing energy for performing the upward movement of the car 51.

As the converter 4 is shown to be installed in series with the counterbalance valve 9, there are three ball valves 2/2, 21, 22, and 23, which are arranged to block the flow to the converter 4 and allow the counterbalance system operation without the converter 4.

With the inventive converter, a high amount of energy can be saved in a hydraulic system such as shown in FIG. 1, as compared to a reference system, in which to converter is present.

With a prototype applied after the counterbalance valve 9, tests have been carried out. In this test, the freight elevator 5 had a capacity to suspend about 300 lbs for a total travel of 2.5 m. Being endowed conventional techniques for handling cargo in hydraulic systems, this equipment has been subjected to comparisons of energy consumption in KW before and after installing the converter. The result was that the energy consumption yielded energy reduction levels close to 40% of electricity demand to perform same work without the converter.

This controller 3 was programmed with two distinct logics, one represent a single conventional hydraulic system and the other with the converter. Both were subjected to the same loading conditions, automation, and the same number of cycles for a fixed period of time. The tests were carried out on a system as depicted in FIG. 2 in that the system was operated according to the following operation table:

| Movement | | | | | | | | |
|---|---|---|---|---|---|---|---|---|
| logic | Counterbalance | | Counterbalance | | Converter | | Converter | |
| operation | 9 upward | | 9 upward | | upward | | Downward | |
| table | movement | | movement | | movement | | movement | |
| Solenoid | OFF | | ON | | OFF | | ON | |
| valve 31 | | | | | | | | |
| Solenoid | ON | | OFF | | ON | | OFF | |
| valve 32 | | | | | | | | |
| Solenoid | OFF | | OFF | | OFF | | OFF | |
| valve 33 | | | | | | | | |
| Solenoid | ON | | ON | | ON | | ON | |
| valve 34 | | | | | | | | |
| Solenoid | OFF | | OFF | | ON | | ON | |
| valve 20 | | | | | | | | |
| Solenoid | OFF | | OFF | | OFF | | OFF | |
| valve 19 | | | | | | | | |
| Electrical | ON | | ON | | OFF | | ON | |
| motor 7a, | | | | | | | | |
| 3.7 kW | | | | | | | | |
| PT 36 | 53 | bar | 57 | bar | 56.4 | bar | 51.2 | bar |
| PT 26 | 63.15 | bar | 79.25 | bar | 67 | bar | 71.5 | bar |
| PT 37 | 5.9 | bar | 7.4 | bar | 14 | bar | x | |
| PT 25 | x | | x | | x | | 68.5 | bar |
| Time | 5.5 | s | 5.2 | s | 4.5 | s | 5.1 | s |
| Power | 5 | W | 5 | W | 0 | W | 5 | W |

consumption

As can be qualitatively seen in the graphs of FIG. 3 for a system with the converter being arranged after the counter balance valve 9, there were performed 8 moves up and down during 2 minutes, the power consumption was 140 watts for conventional hydraulic system, and reduced to 80 watts when operating with converter 4, resulting in savings of 43% of energy consumption for performing identical work up and down 192 kg by the distance of 2.5 meters.

Applying the converter as in FIG. 2 before the counterbalance valve 9 in downward movement, the results were even better: the system performed with 50% less power demand and 2% faster than the conventional one, as can be seen from the above table.

The operations are characterized as continuous or intermittent, depending on the number of cycles per time of the hydraulic actuator's frequency. This frequency is factor for obtaining the product's best performance of the system in question. This division proved to be necessary because its significant cost of components. Thus customization for application is the ideal tool for viability in the marketplace. The big difference between the two conditions is mainly the existence of one or more hydraulic accumulator 2.

The embodiment discussed with respect to FIGS. 1 through 3, as well as the one shown in the diagram of FIG. 4, work according to the intermittent model. In case of the elevator 5, only the downward motion “fills” the one accumulator 2 of the converter 4, thus, the loading of the accumulator is carried out intermittently.

The embodiment in FIG. 4 differs from the one shown in the above figures in that the drive or motor is a hydraulic linear motor 80 with a piston 81 and a plunger 82 moving therein. Again, with only one accumulator 2, this one is loaded only during one stroke in one direction whereas it is unloaded during the motion of the plunger 82 in the opposite direction. The function of the embodiment is basically the same as discussed with respect to FIG. 2.

FIG. 5 shows a modification of the embodiment of FIG. 2, modified for running the continuous mode. In this case, two accumulators 2 and 28 are present in the converter 4. This model works alternately, one accumulator 2 accumulates the energy that the system is losing while the other 28 returns it to the system. That way, the plunger's 82 motion leads to compressing and thus energizing fluid on one side, loading e.g. accumulator 2 and being supported on the other side by “unloading” accumulator 28. On the backstroke, plunger is supported by “unloading” accumulator 2 (loaded before) and compresses fluid to eventually load accumulator 28. By this, energy can be gained from every stroke the linear hydraulic motor 80 carries out.

The hydraulic energy converter can be applied to any hydraulic fluid system. This hydraulic energy converter was developed to capture the fluid kinetic energy, convert it into piezometric pressure fluid energy, stores it for a wide range periods and reconverts it into fluid kinetic energy, whenever the system demands additional hydraulic energy. This entire process is done automatically through hydraulic components and consumer electronics, such as: electro hydraulic directional valves, or discrete signals proportional valves, pressure control, manual or electric, pressure transmitters and pressure switches, hydraulic accumulators, programmable logic controllers signals and electrical.

1. A hydraulic energy converter capable of being connected to a hydraulic system, the converter comprising:
a manifold device for controlling hydraulic fluid flow,
a controller for controlling the manifold device, and
at least one accumulator connected to the manifold device for storing hydraulic energy supplied by the hydraulic system via the manifold device.

2. The hydraulic energy converter according to claim 1, wherein at least two accumulators are connected to the manifold device.

3. The hydraulic energy converter according claim 1, further comprising at least one supply line connected to the manifold device for receiving hydraulic fluid from the hydraulic system in order to store hydraulic energy in said at least one accumulator, and said at least one supply line is further adapted for supplying hydraulic fluid pressurized by the hydraulic energy stored in said at least one accumulator to said hydraulic system.

4. The hydraulic energy converter according to claim 3, wherein the manifold device comprises at least one switch allowing a fluid flow to and/or from said at least one accumulator.

5. The hydraulic energy converter according to claim 4, wherein said at least one switch is a valve.

6. A method for working a hydraulic system, said system including a hydraulic drive driven by hydraulic fluid flow and, hydraulic lines to provide the hydraulic fluid flow to and from said hydraulic drive, via a counterbalance valve, wherein, particularly in line with said counterbalance valve, a hydraulic converter is arranged in the hydraulic system, wherein said hydraulic converter stores energy produced by fluid flowing back from said hydraulic drive in at least one accumulator, wherein if the pressure of the fluid flowing back exceeds a threshold value the hydraulic converter supplies energy, stored in the at least one accumulator, to the hydraulic drive, in case said hydraulic drive requires energy.

7. The method according to claim 6, wherein said hydraulic converter uses two accumulators, one receiving energy from the hydraulic drive, and simultaneously, the other supplying energy to the hydraulic drive.
